(19) United States
(12) Patent Application Publication
(10) Pub. No.: US 2009/0267717 A1
(43) Pub. Date: Oct. 29, 2009

(54) Magnetic Mat for Holding Surgical Instruments

(76) Inventor: Michael D. Baskett, Centreville, VA (US)

Correspondence Address: SHAWNA J. SHAW, 15151 STRATTON MAJOR CT., CENTERVILLE, VA, 20120, US

(21) Appl. No.: 12/109,298

(22) Filed: Apr. 24, 2008

(51) Int. Cl. H01F 7/20

(52) U.S. Cl. 335/285

(57) ABSTRACT

A magnetic mat for holding surgical instruments. The mat includes a plurality of magnet holders configured to removably receive magnets therein. The magnet holders are connected together using a plurality of links so as to form a two dimensional mat adjustable in size. As a result, the effective magnetic surface area of the mat may be extended to provide adequate coverage for larger patients and thereby prevent instruments from falling off the patients' surface. In embodiments, the magnet holders may be opened such that different magnets may be inserted, removed, replaced and/or exchanged. Additionally, the magnet holders, links, and/or magnets may be independently sterilized, and/or replaced. In embodiments, the magnet holders include an open cage structure to hold a magnet with minimal obstruction of its magnetic field.

### BACKGROUND OF THE INVENTION

1. Field of the Invention

The present invention generally relates to a surface for retaining articles. More specifically, the present invention relates to a magnetic mat for holding surgical instruments.

2. Description of Related Art

It is common for surgical procedures to require many different surgical instruments such as scalpels, forceps, needles, sharps, scissors, clamps, etc. Typically, medical personnel will place instruments on the patient surface for easy access and to create a safe transfer zone. Such a hands-free practice reduces the risk of percutaneous injury to medical personnel as well as the possibility of dropping the instruments as a result of being passed back and forth.

During the course of a procedure, it is highly important that surgical instruments do not fall to the floor. If an instrument does happen to fall, it becomes contaminated and therefore cannot be used again until re-sterilized. As a result, the surgical procedure may be unnecessarily delayed until the contaminated instrument has been re-sterilized. In some cases, another sterile instrument may be available, however introducing additional instruments typically adds to the overall cost of the procedure. As a result of prolonging the procedure, the patient is placed at a higher risk of infection or other serious complications. In addition, other surgeries may be subsequently delayed, and time wasted on the part of the surgeon and other hospital staff.

In order to avoid dropping surgical instruments, various drapes have been developed to help hold instruments in place adjacent to a surgical site. For example, U.S. Pat. No. 5,036,866 to Eldridge, Jr., et al. discloses a surgical drape having dedicated magnetized and non-magnetized portions. The magnetized portion comprises magnets embedded in the fabric of the drape and are used to retain surgical instruments on the surface of the drape. However, because of the dimensions of the magnetized and non-magnetized portions, the instruments must be placed in designated areas. Unfortunately such designated areas may not be convenient for the surgeon and/or may become crowded by other instruments. Moreover, magnets incorporated into the fabric of the drape tend to become compromised and/or break through the fabric of the drape as a result of repeat sterilization. If the integrity of such drapes and/or magnets become compromised, both the drape and magnets must be discarded.

U.S. Patent Publication No. 2004/0118410 to Griesbach, III et al. discloses a surgical drape having an integral instrument holder. Such drapes require instruments to be placed in a designated tray which also may be inconvenient to the surgeon. Additionally, such trays tend to become crowded with other instruments making it more difficult to access a particular instrument when needed quickly. Moreover, if the instrument holder is not able to rest on a flat surface, it may rock or lie at a sloped angle causing instruments to slide.

Another significant drawback of conventional drapes is that the actual magnetic surface area is relatively small. This is a particular problem concerning large or obese patients who tend to exhibit more curved or sloped surface areas when lying on an operating table. As a result, instruments placed outside of the effective magnetic area of a drape will likely roll, slip, or otherwise fall, off of the patient surface.

Another problem associated with conventional magnetic drapes, as alluded to above, is that of sterilization. Reusable surgical instruments and accessories are typically sterilized in autoclaves or other devices at high temperatures (e.g., around 121-134° C., or higher). If the drape comprises magnets or magnetic particles incorporated into the fabric, the magnets are exposed to high temperatures every time the drape is sterilized. Exposure to such high temperatures tends to reduce or compromise the attractive magnetic force. Thus, repeat heat sterilization can have life-shortening effects on magnets. In addition, because it is difficult to sterilize large drapes due to the size of the autoclave or sterilization device, such drapes tend to be small. As a result, when these small drapes are used for larger or obese patients, surgical instruments are not able to be effectively retained on the patient surface.

Although disposable or single-use drapes can avoid some of the above mentioned sterilization problems, such drapes that incorporate magnets tend to be expensive. To reduce costs, the number of magnets (and therefore the magnetic surface area) is kept relatively small—again leading to the above drawbacks associated with larger or obese patients. Moreover, once these drapes have been used, both the drape and the magnets must be discarded, thereby wasting the magnets.

Accordingly, there is a need for a mat for holding surgical instruments, wherein the effective magnetic surface area may be extended to account for the size and/or shape of a patient.

There is also a need for a mat for holding surgical instruments, wherein the mat includes magnets that may be easily inserted, removed, replaced and/or exchanged.

Additionally, there is a need for a mat for holding surgical instruments, wherein at least portions of the mat may be easily and/or independently sterilized.

There is further a need for a mat for holding surgical instruments, wherein at least portions of the mat may be easily and/or independently replaced.

### SUMMARY OF THE INVENTION

The present disclosure provides solutions to needs in the art by providing an expandable magnetic mat for holding surgical instruments wherein the overall size of the mat may be advantageously adjusted e.g., to account for patient size. Additionally, the mat of the present disclosure includes a plurality of magnet holders for holding magnets such that the magnets may advantageously be inserted, removed, replaced and/or exchanged. Furthermore, the mat of the present disclosure includes a plurality of links for connecting the magnet holders in a manner that the mat may be easily disassembled after use and portions thereof individually sterilized or replaced as needed. Additionally, the mat may be used alone or alternatively under, or over, a standard surgical drape.

According to one aspect, a magnetic mat for holding surgical instruments on a patient surface is disclosed, the mat comprising: a plurality of magnet holders, each magnet holder having a space for receiving a magnet; a plurality of magnets, each magnet disposed in a magnet holder; and a plurality of links, each link having first and second end portions configured to engage a magnet holder and connect the magnet holders together so as to form a two dimensional magnetic mat, whereby the overall size of the mat may be adjusted. In one example, the size of the mat may be expanded to account for patient size. The magnet holders and/or links may be comprised of e.g., stainless steel, plastic, rubber, or other conventional materials suitable for re-sterilization and/or the functions disclosed herein. Preferably, the magnet holders are capable of removably receiving magnets of different sizes and/or magnetic field strengths. In embodiments, the magnet holders include a plurality of peripheral notches, or troughs, that securely receive the link end portions. In further embodiments, the magnet holders include an open cage structure for holding a magnet with minimal obstruction of its magnetic field.

According to another aspect, a kit for a magnetic mat is disclosed, the kit comprising: a plurality of magnet holders, each magnet holder having a space for receiving a magnet; a plurality of magnets; and a plurality of links, each link having first and second end portions configured to engage the magnet holders and connect the magnet holders together so as to form a two dimensional magnetic mat. The magnet holders and links may be comprised of e.g., stainless steel, plastic, rubber, or other conventional materials suitable for re-sterilization and/or the functions disclosed herein. Preferably, the magnet holders are capable of removably receiving magnets of different sizes and/or magnetic field strengths. In embodiments, the magnet holders include a plurality of peripheral notches, or troughs, that securely receive link end portions. In further embodiments, the magnet holders include an open cage structure for holding a magnet with minimal obstruction of its magnetic field.

According to yet another aspect, a magnetic mat for holding surgical instruments on a patient surface is disclosed, the mat comprising: a plurality of magnet holders, each magnet holder having a space for receiving a magnet; a plurality of magnets, each magnet disposed in a magnet holder; and means for connecting the magnet holders together so as to form a two dimensional magnetic mat. In one embodiment, the connecting means comprises a plurality of links. In other embodiments, the connecting means may be a sheet of material. The magnet holders and/or connecting means may be comprised of e.g., stainless steel, plastic, rubber, or other conventional materials suitable for re-sterilization and/or the functions disclosed herein. In embodiments, the magnet holders are capable of removably receiving magnets of different sizes and/or magnetic field strengths. In further embodiments, the magnet holders include an open cage structure for holding a magnet with minimal obstruction of its magnetic field.

### BRIEF DESCRIPTION OF THE DRAWINGS

FIG. 1 depicts an adjustable magnetic mat according to an exemplary embodiment of the present disclosure.

FIG. 2a depicts a top view of a magnet holder bottom portion according to the embodiment of FIG. 1.

FIG. 2b depicts a top view of a magnet holder top portion according to the embodiment of FIG. 1.

FIG. 2c depicts a side view of the magnet holder bottom portion according to FIG. 2a.

FIG. 2d depicts a side view of the magnet holder bottom portion as shown in FIG. 2c, with a magnet held therein.

FIG. 3 depicts a link having first and second ends for connecting magnet holders according to the embodiment of FIG. 1.

FIG. 4 depicts a link integral with a magnet holder according to another exemplary embodiment.

### DETAILED DESCRIPTION OF VARIOUS EMBODIMENTS OF THE INVENTION

Reference will now be made in detail to various exemplary embodiments of the invention, examples of which are illustrated in the accompanying drawings. The following detailed description is provided to supply a fuller description of certain embodiments of the invention, and is not intended as a limiting disclosure of all embodiments of the invention. Rather, those of skill in the art will be able to understand the full scope of the invention after consideration of the above broad description, the following detailed description of certain preferred embodiments, and the claims.

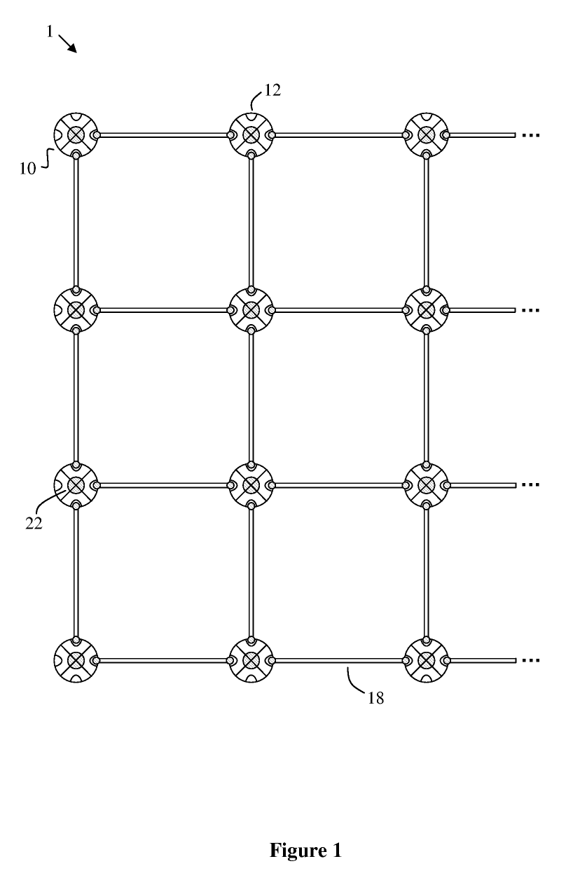

FIG. 1 depicts a magnetic mat 1 for holding metal surgical instruments on a patient surface. It is appreciated that the figure is meant to be illustrative and is not limited to the dimensions or configurations shown. In general, the mat 1 includes a plurality of magnet holders 10 for holding magnets 22 and a plurality of links 18 that connect the magnet holders 10 together in two dimensions. Preferably, the overall size of the mat 1 is adjustable. To this end, the dotted lines serve to indicate that more magnet holders 10 and/or links 18 may be added to extend the size of the mat (in one or more directions) according e.g., to patient size. Extending the magnetic surface area of the mat in such a manner is particularly helpful for preventing instruments from slipping off sloped surfaces of large or obese patients, for example.

Magnet holders 10 and/or links 18 may be composed of stainless steel, plastic, rubber, or any other conventional materials which may be readily sterilized and/or perform the functions disclosed herein. For example, it is appreciated that stainless steel materials may be used in situations where long-lasting and/or heavier components are needed. Plastic materials may be used in applications where less expensive and/or lightweight components are desired. In addition, plastic materials that have a certain degree of pliability may be used for links 18 to add to the overall flexibility of the mat 1. Rubber or high friction materials, for example, may also help to keep non-metal instruments from sliding off a patient surface. It is also appreciated that magnet holders 10 and links 18 may be composed of the same, or different, types of materials.

Preferably, the magnet holders 10 allow magnets 22 to be inserted, replaced, removed and/or exchanged. Such a feature is useful for independently sterilizing the magnet holders 10, links 18, and/or magnets 22 according to temperatures and/or techniques appropriate for the material(s) of each component. For example, if plastic materials are used for magnet holders 10 and/or links 18, sterilization techniques may be used that do not rely on high temperatures. Preferably, the magnets 22 are sterilized using a method other than steam or dry heat. If certain components eventually become compromised or broken, they may be separately discarded. As a result, the useful life of the remaining components is extended and cost savings are achieved.

The magnet holders 10 are preferably sized to receive conventional magnets capable of providing adequate magnetic fields for attracting metal surgical instruments. Moreover, it is desired that the magnet holders 10 have as low of a profile as possible so as to conform closely to the patient (not shown) and not interfere with the surgical procedure. In addition, links 18 may also assume various dimensions depending upon the particular application, however according to one exemplary embodiment are on the order of 8 cm long.

In operation, the magnetic mat 1 is draped over a patient such that a sufficient surface area of the patient is covered to keep instruments from slipping or falling. If the patient is large or obese, the adjustable mat 1 is advantageously able to provide a larger effective magnetic surface area for retaining surgical instruments and to prevent them from falling. It is appreciated that the mat 1 may be used alone or alternatively may be placed over, or under, one or more standard surgical drapes.

Advantageously, the mat 1 may be disassembled after use so that the magnet holders 10, links 18 and/or magnets 22 can be individually sterilized. Consequently, large autoclaves are not required for sterilizing the entire mat. Additionally, the magnet holders 10, links 18 and/or magnets 22 may be sterilized according to the optimal temperature and technique for that particular material. For example, if plastic materials are used for magnet holders 10 and/or links 18, sterilization techniques may be used that do not rely on high temperatures. Moreover, the magnets 22 may be sterilized using a method other than steam or dry heat. As a result, magnets 22 do not need to be exposed to higher temperatures which may cause the magnets 22 to weaken or otherwise become compromised.

Even if one or more individual components eventually become weakened or compromised, those components may be discarded without affecting other viable components. For example, a link 18 that becomes broken may be readily discarded without having to discard the remaining components. As a result, cost savings are achieved and waste is reduced.

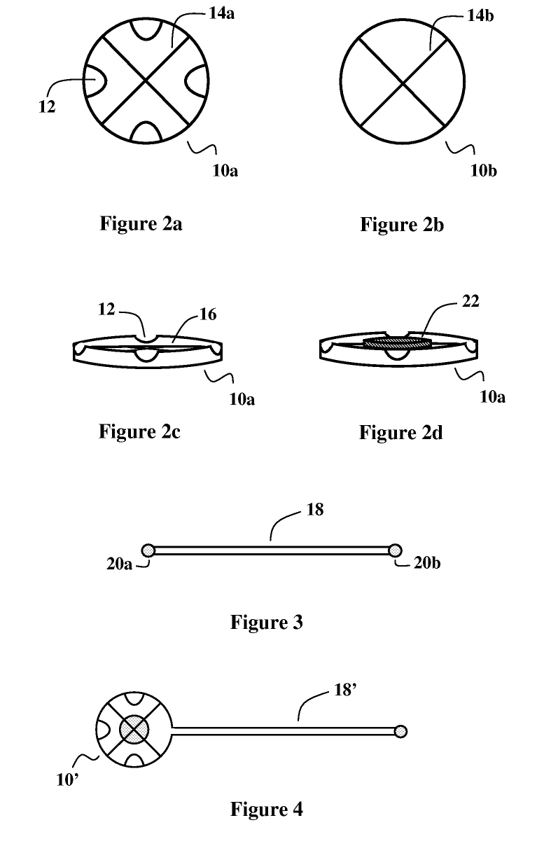

FIG. 2a depicts a magnet holder bottom portion 10a. In this embodiment, the bottom portion 10a includes an open cage structure 14a for retaining a magnet 22 (not shown in this figure) in the magnet holder 10. One advantage of an open cage structure 14a is that the magnetic field strength of the magnet 22 is not reduced by intervening fabric or other materials. Moreover, although depicted as an “x-shape,” it is understood that the cage structure is not limited to this configuration and that other arrangements may be used depending upon the particular application. What is important in this embodiment, is that the magnet 22 is held by the magnet holder 10 with minimal obstruction of the effective magnetic field. For example, by obstructing the magnetic field as little as possible, smaller magnets or larger spacings between the magnets may be used thereby allowing for a more flexible or lightweight mat 1. Also shown in FIG. 2a is a plurality of peripheral notches, or troughs, 12. Each notch 12 securely receives an end portion (20a or 20b, see FIG. 3) of link 18. For example, the notches 12 may be configured such that an end portion of a link 18 is securely “snapped” into the notch 12.

Similarly, FIG. 2b depicts an optional magnet holder top portion 10b. Although “top” and “bottom” are used here, it is understood that these are relative terms and therefore may be reversed as necessary. In the embodiment shown, top portion 10b also comprises a cage structure 14b. However, it is possible that only one portion 10a or 10b includes a cage structure. It is further understood that the configurations of 14a and 14b may be the same, or different. It is also possible that in some embodiments, only a one-sided cage (e.g., bottom portion 10a) is used. In this case, magnets 22 can be individually placed in each cage which is made of stainless steel, for example.

The magnet holder bottom and top portions 10a and 10b may be coupled together to form magnet holder 10 for securely holding a magnet 22. In embodiments, the bottom portion 10a and top portion 10b are coupled such that the magnet holder 10 may be opened for inserting, removing, replacing and/or exchanging magnets 22. It is appreciated that bottom and top portions 10a and 10b may be coupled together by hinges, pins, clamps, or the like. In other embodiments, the bottom and top portions 10a and 10b are integral or sealed together e.g., by soldering, welding, injection molding, or the like. Instead of an open cage structure, it is possible that magnet holders 10 may be sealed so as to be impermeable to fluids, liquids, etc.

FIGS. 2c and 2d illustrate a side view of the magnet holder bottom portion 10a. Referring to FIG. 2c, the bottom portion 10a includes an interior space 16 for receiving a magnet 22 (see FIG. 2d). Also depicted are side views of notches 12 for securely receiving link end portions (20a or 20b, see FIG. 3). Although the figures show magnet holders 10 having four peripheral notches 12, it is understood that other configurations may be used depending upon various design considerations. For example, magnet holders 10 may comprise three equally spaced notches 12, allowing the magnet holders 10 to be connected in a triangular configuration.

FIG. 3 illustrates a single link 18 for connecting magnet holders 10 together. In the embodiment shown, link 18 includes two ball-shaped end portions 20a and 20b. However, it is understood that the end portions 20a and 20b may include buttons, knobs, or other various shapes or configurations depending upon the particular application. In one preferred example, the end portions 20a and 20b are configured to securely snap into notches 12 for quick assembly and disassembly of the mat 1. Materials for links 18 include, but are not limited to, stainless steel, plastic, rubber, or other conventional materials suitable for re-sterilization and/or the functions disclosed herein. For example, stainless steel may be used in applications where long-lasting and/or heavier materials are needed. Plastic materials may be used to provide cheaper, lightweight, and/or more pliable alternatives. Rubber or high friction materials, for example, may also help non-metal instruments from sliding off a patient surface. The dimensions of links 18 may vary depending upon the particular application, however in one example may be on the order of 8 cm long.

Where a kit is provided, the kit may include links 18 of various lengths for assembling mats 1 of different dimensions and/or uses. In addition, magnets of various sizes and/or magnetic field strengths may be included in the kit e.g., to be used with certain size links (associated with different spacings) or for attracting different types of surgical instruments.

FIG. 4 illustrates another embodiment where a magnet holder 10′ is permanently coupled to its own link 18.′ For example, the magnet holder 10′ and link 18′ may be coupled by a simple hinge to allow the mat 1 to drape over a patient with as low a profile as possible. This embodiment is useful for simplifying and/or minimizing assembly time of mat 1. In addition, FIG. 4 serves to show one of several possible alternative designs according to the principles of the present disclosure.

It can be seen that the magnet holders 10 and links 18 as disclosed enable mat 1 to be extended to account for patient size. Advantageously, the effective magnetic surface area may be extended to adequately cover large or obese patients and thereby prevent instruments from slipping or falling. Additionally or alternatively, the size of the mat 1 may be constructed to fit a particular surgical site on the body. For example, narrow or elongated mats 1 may be assembled to cover extremities. In addition, the magnet holders 10 hold magnets such that they may be readily inserted, removed, replaced, and/or exchanged. As a result, magnets may be re-sterilized using appropriate techniques and reused—thereby extending the life of the magnets and achieving cost savings. Moreover, because the individual components take up less space when disassembled, they do not require large autoclaves for sterilization.

It will thus be apparent to those skilled in the art that various modifications and variations can be made in the practice of the present disclosure without departing from the scope or spirit of the disclosure. For example, it is appreciated that magnet holders 10 may be connected, or held, together by a single sheet of material instead of by links 18. In this case, the magnet holders 10 are coupled to a continuous two dimensional sheet of material at certain intervals. The sheet of material may further serve as a surgical drape and be comprised e.g., of fabric, plastic, rubber, paper, or any other conventional material(s). In some cases, the magnet holders 10 may be coupled to the sheet by means of pockets, flaps, or other similar means. Such pockets or flaps may be coupled to the sheet e.g., by sewing, heat sealing, hook and loop fasteners, or the like. Accordingly, the magnets 22 may be inserted, removed, replaced and/or exchanged from the pockets, flaps or other similar means. Such features are advantageous because the magnets may be removed and reused even if the sheet is to be discarded. Moreover, other embodiments of the invention will be apparent to those skilled in the art from consideration of the specification and claims, and from practice of the disclosure. It is intended that the specification be considered as exemplary only.

1. A magnetic mat for holding surgical instruments on a patient surface, the mat comprising:
a plurality of magnet holders, each magnet holder configured to removably receive a magnet;
a plurality of magnets, each magnet disposed in a magnet holder; and
a plurality of links, each link having first and second end portions configured to engage a magnet holder and connect the magnet holders together so as to form a two dimensional mat, whereby the overall size of the mat may be adjusted.

2. The magnetic mat of claim 1, wherein the size of the mat is adjusted according to patient size.

3. The magnetic mat of claim 1, wherein the magnet holders are comprised of stainless steel.

4. The magnetic mat of claim 1, wherein the magnet holders are comprised of plastic.

5. The magnetic mat of claim 1, wherein the magnet holders are capable of removably receiving magnets of different sizes and/or magnetic field strengths.

6. The magnetic mat of claim 1, wherein the links are comprised of stainless steel.

7. The magnetic mat of claim 1, wherein the links are comprised of plastic.

8. The magnetic mat of claim 1, wherein the magnet holders include an open cage structure.

9. The magnetic mat of claim 1, wherein the magnet holders include a plurality of notches capable of securely receiving link end portions.

10. A kit for a magnetic mat to hold surgical instruments, the kit comprising:
a plurality of magnet holders, each magnet holder configured to removably receive a magnet;
a plurality of magnets; and
a plurality of links, each link having first and second end portions configured to engage the magnet holders and to connect the magnet holders together so as to form a two dimensional mat.

11. The kit of claim 10, wherein the magnet holders are capable of removably receiving different magnets.

12. The kit of claim 10, wherein the kit includes magnets of different sizes and/or magnetic field strengths.

13. The kit of claim 10, wherein the kit includes different sized links.

14. The kit of claim 10, wherein the magnet holders include a plurality of notches capable of securely receiving the link end portions.

15. A magnetic mat for holding surgical instruments on a patient surface, the mat comprising:
a plurality of magnet holders, each magnet holder configured to removably receive a magnet;
a plurality of magnets, each magnet disposed in a magnet holder; and
means for connecting the magnet holders together so as to form a two dimensional mat.

16. The magnetic mat of claim 15, wherein the means for connecting comprises a plurality of links.

17. The magnetic mat of claim 15, wherein the magnet holders are capable of removably receiving magnets of different sizes and/or strengths.

18. The magnetic mat of claim 15, wherein the magnet holders include an open, cage structure.

19. The magnetic mat of claim 15, wherein the magnet holders are comprised of plastic.

20. The magnetic mat of claim 15, wherein the magnet holders are comprised of stainless steel.
